(19) United States
(12) Patent Application Publication
(10) Pub. No.: US 2002/0123258 A1
(43) Pub. Date: Sep. 5, 2002

(54) Quick-connect/disconnect electrical connector with visual connection indicator

(76) Inventor: Richard M. Koch, Wakefield, MA (US)

Correspondence Address: Grossman, Tucker, Perreault & Pfleger, PLLC, Suite 604, 795 Elm Street, Manchester, NH, 03101, US

(21) Appl. No.: 10/074,593

(22) Filed: Feb. 12, 2002

Related U.S. Application Data
(60) Provisional application No. 60/268,164, filed on Feb. 12, 2001.

(51) Int. Cl. H01R 13/213

(52) U.S. Cl. 439/315

(57) ABSTRACT

A quick-connect/disconnect electrical connector including an indicator ring that is obscured from visual perception when the connector is fully engaged with a mating connector. In one embodiment, the connector includes an inner shell; a coupling shell disposed about the inner shell; and a compression spring disposed between the inner shell and the coupling shell for biasing the coupling shell toward a mating end of the connector. The indicator ring is positioned on the inner shell to be obscured by the coupling shell when a complete engagement between the connector and mating connector is achieved. The coupling shell may also include a radial flange on an exterior surface thereof to facilitate manual retraction of the coupling shell against the bias of the compression spring.

### CROSS REFERENCE TO RELATED APPLICATIONS

The present application claims the benefit of the filing date of U.S. Provisional Application Ser. No. 60/268,164, filed Feb. 12, 2001, the teachings of which are incorporated herein by reference.

### FIELD OF THE INVENTION

The present invention relates in general to electrical connectors, and in particular to an electrical connector assembly suitable for wireless applications and having a quick on/off coupling mechanism

### BACKGROUND OF THE INVENTION

In many applications a facile means of making electrical connections between various electrical components is desirable. For coaxial cable connectors, various connection means have been developed, e.g. screw-on, and plug and jack connections. Plug and jack type connections provide quick connect/disconnect features, but fail to provide positive interlock between the plug and jack portions. This can lead to inadvertent disconnection between the plug and jack, e.g. by contact with the cable assemblies connected to the plug and/or jack. Screw-on plug and receptacle connector assemblies provide positive interlocking between the assembly portions, but can require cumbersome and time-consuming screw-on mating, especially when a large number of connections/disconnections or frequent connection/disconnection is required. In addition, typical assemblies fail to provide a positive visual or mechanical indication that the receptacle portions are fully mated. This can lead to inadvertent mismating of the assembly halves, and corresponding malfunction of associated equipment.

Accordingly, there is a need for a connector and connector assembly that allows facile connection/disconnection of plug and receptacle assembly portions and provides visual indication of positive engagement of the plug and receptacle assembly portions.

### SUMMARY OF THE INVENTION

According to one aspect of the invention, there is provided an electrical connector including an indicator ring that is obscured from visual perception when the connector is fully engaged with a mating connector. In one embodiment, the connector includes an inner shell; a coupling shell disposed about the inner shell; and a compression spring disposed between the inner shell and the coupling shell for biasing the coupling shell toward a mating end of the connector. The inner shell includes portions defining at least one opening and at least one locking element disposed in the opening with a portion of the locking element being forced radially inward beyond an inner surface of the inner shell by the coupling shell. The coupling shell includes a beveled surface adjacent the first surface, wherein upon axial movement of the coupling shell away from the mating end the beveled surface aligns with the at least one opening thereby allowing the locking element to recede within the opening toward the beveled surface. The indicator ring is positioned on the inner shell to be obscured by the coupling shell when a complete engagement between the connector and mating connector is achieved. The coupling shell may also include a radial flange on an exterior surface thereof to facilitate manual retraction of the coupling shell against the bias of the compression spring.

### BRIEF DESCRIPTION OF THE DRAWING

For a better understanding of the present invention, together with other objects, features and advantages, reference should be made to the following description of the preferred embodiment which should be read in conjunction with the following figures wherein like numerals represent like parts:

FIG. 1: is a partial sectional view of an exemplary plug portion of a connector assembly consistent with the invention;

FIG. 2: is a partial sectional view of an exemplary receptacle portion of a connector assembly consistent with the invention; and

FIG. 3: is an end view of the exemplary receptacle illustrated in FIG. 2.

### DETAILED DESCRIPTION

The present invention will now be described in connection with an exemplary embodiment wherein a receptacle portion of the connector assembly is adapted to mount to an instrument panel, or the like. Those skilled in the art will recognize, however, that the advantages of the invention could be incorporated into many connector designs. It is intended, therefore, that the invention not be limited to the specific embodiment described, but include any variation thereof associated with use in varied connector schemes and designs.

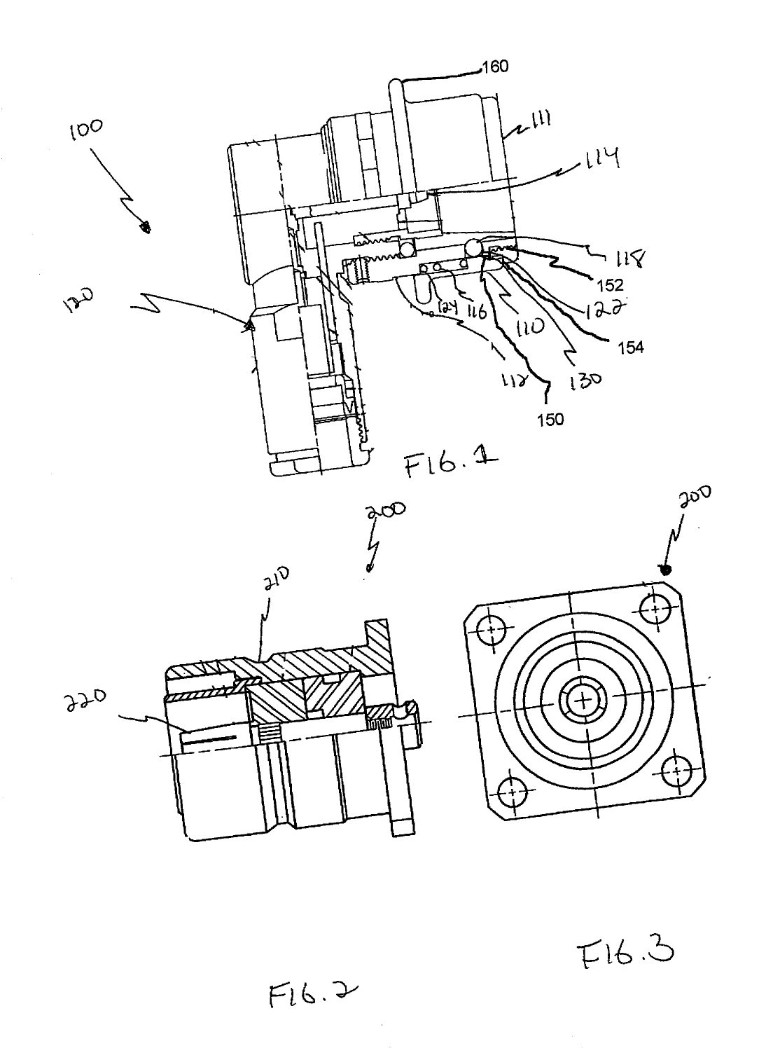

Turning to FIGS. 1-3, an exemplary assembly consistent with the invention generally includes a plug portion 100 and a mating receptacle portion 200. In the illustrated embodiment, the plug portion 100 includes a coupling shell 110, an inner shell 112, an end shell 111, a center conductor 114, a compression spring 116, and ball bearing locking elements 118. As shown, the center conductor 70 is disposed in a fixed axial position within an opening defined by the connector body and is electrically connected to a conductor received within a known right angle adaptor 120. The right angle adaptor includes threads on an end thereof that mate with corresponding threads on the plug to secure the plug to the right angle adaptor.

The inner shell portion 112 is generally cylindrical in shape and is formed with portions defining openings 122 in the walls thereof that are sized to receive the ball bearing locking elements 118. In one embodiment, five equally spaced openings may be provided for receiving associated locking elements 118. The portions defining the openings include beveled inner surfaces that cause the diameter of the openings to diminish toward the inner surface of the inner shell. The ball bearing locking elements, therefore, may be received within the openings, but the bottom portion of the openings has a diameter that allows only a portion of the ball bearing locking elements to extend inward beyond the inner surface of the inner shell.

The inner shell portion includes an enlarged diameter portion at a rear end thereof with a circumferential projection. A shelf 124 is formed on the exterior of the inner shell portion. The shelf provides a surface against which the bottom of the cylindrical compression spring 116 rests. The top of the compression spring engages a shelf formed on the interior of the generally cylindrical coupling shell 110 that is disposed around the inner shell portion.

At a forward end of the inner shell, threads 152 are provided for meshingly engaging corresponding threads on the end shell 111. In the illustrated embodiment, the end shell includes a shelf 154 that acts as a stop for the coupling shell. The coupling shell is biased against the shelf 154 by the compression spring. The compression spring, therefore, continuously biases the coupling shell against the shelf in a direction toward a mating connector, e.g. a receptacle 200. The spring force of the compression spring is selected so that it may be overcome by physically forcing the coupling shell axially reward.

The coupling shell includes an enlarged diameter portion which is normally positioned directly over the openings 122 in the inner shell in which the ball bearing locking elements are disposed. This portion forces the ball bearings radially inward so that portions thereof extend radially inward beyond the inner surface of the inner shell, as shown in FIG.1. A beveled surface 130 of the enlarge diameter portion is positioned adjacent the openings toward the forward end of the connector.

Connection between the plug 100 and the receptacle 200 is established by retracting the coupling shell 110 against the bias of the compression spring 116. A radial flange 160 may be provided on the outside of the coupling shell for facilitating retraction of the coupling shell. Retraction of the coupling shell brings the beveled inner surface 130 of the coupling shell into alignment with the openings 122, thereby allowing the ball bearing locking elements 118 to recede inward relative to the inner surface of the inner shall and against the beveled inner surface of the coupling shell.

Once the ball bearings are free to recede into the openings and beyond the inner surface of the inner shell, the plug 100 mates with the receptacle 200 until the locations of the ball bearings correspond axially with the location of a groove 210 in the receptacle. Correspondingly, the center conductor 220 of the receptacle aligns and mates with the center conductor 114 of the plug to create an electrical path through the plug 100 and the receptacle 200.

The coupling shell is then released and the compression spring forces the coupling shell in the direction of the receptacle, thereby forcing the bearings 122 outward relative to the inner surface of the inner shell and into the groove 210 in the receptacle. The engagement of the ball bearings with the groove locks the plug to the receptacle.

Advantageously, a connector consistent with the present invention includes an indicator ring 150 that provides visual indication of incomplete engagement of the plug with the adaptor. In the illustrated exemplary embodiment, the indicator ring is disposed circumferentially around the inner shell adjacent the end shell 111 at the side of the opening closest the mating end of the plug. The ring may be a shrink-wrapped plastic element of a particular color, e.g. red. When the plug and receptacle are fully mated, the ring 150 is obscured from visual perception by the coupling shell. However, in the event of an incomplete engagement, the locking elements 118 would prevent the coupling shell from moving fully forward under the bias of the compression spring. In this condition, the indicator ring 150 is visible to provide a visual indication of an incomplete engagement. It is noted that the indicator ring may also be placed on the inner shell adjacent the end of the coupling shell distal from the mating end of the connector. In this configuration, the ring may be visible when a complete engagement occurs between the plug and receptacle.

The illustrated embodiment thus provides a quick on/off spring-loaded coupling mechanism with a visual indication of engagement/disengagement. The coupling mechanism provides positive locking between the plug and the receptacle and eliminates the need for installation tools. These advantages may be provided in a in a 716type connector with 50 ohm matched impedance that is suitable for wireless applications and provides excellent IMD performance.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of this invention.

What is claimed is:

1. An electrical connector comprising:
an inner shell;
an indicator ring disposed on said inner shell
a coupling shell disposed about said inner shell; and
a compression spring disposed between said inner shell and said coupling shell for biasing said coupling shell toward a mating end of said connector,
said inner shell including portions defining at least one opening and at least one locking element disposed in said opening with a portion of said locking element being forced radially inward beyond an inner surface of said inner shell by said coupling shell, said coupling shell including a beveled surface adjacent said first surface, wherein upon axial movement of said coupling shell away from said mating end said beveled surface aligns with said at least one opening thereby allowing said locking element to recede within said opening toward said beveled surface,
said indicator ring being positioned on said inner shell to be obscured by said coupling shell when a complete engagement between said connector and mating connector is achieved.

2. A connector according to claim 1, wherein said coupling shell includes a radial flange on an exterior surface thereof.
